(19) United States
(12) Patent Application Publication
(10) Pub. No.: US 2009/0299833 A1
(43) Pub. Date: Dec. 3, 2009

(54) Messaging Gaming Patrons

(76) Inventors: Eugene Estep, Shawnee, OK (US); Fredrick C. Combs, Shawnee, OK (US)

Correspondence Address: FISH & RICHARDSON P.C., PO BOX 1022, MINNEAPOLIS, MN, 55440-1022, US

(21) Appl. No.: 12/416,297

(22) Filed: Apr. 1, 2009

Related U.S. Application Data
(60) Provisional application No. 61/041,531, filed on Apr. 1, 2008.

(51) Int. Cl. G06Q 30/00; G10L 13/00

(52) U.S. Cl. 705/14.1; 704/258; 704/E13.001

(57) ABSTRACT

The subject matter of this specification can be embodied in, among other things, a method that includes monitoring game play information transmitted from a gaming device to a server. The monitored information specifies a gaming patron's interactions with the gaming device. The method also includes recording, in a data store of the server, player information comprising the game play information for the gaming patron and a communication device identifier that specifies a communication device associated with the gaming patron. The method includes generating at the server an electronic message that includes one or more offers personalized for the gaming patron based on the recorded player information and transmitting, using a messaging interface, the electronic message to the communication device specified by the communication device identifier.

This application is a non-provisional utility application that claims the benefit of U.S. Provisional Application No. 61/041,531, filed Apr. 1, 2008, which is incorporated by reference in its entirety here.

### TECHNICAL FIELD

This specification relates to messaging gaming patrons who frequent gaming facilities.

### BACKGROUND

Some gaming facilities provide gambling or other services to anyone who may want to gamble, play amusement devices, enjoy entertainment, etc. Some gaming facilities may want to provide incentives to current and potential customers in order to attract customers and generate more revenue. Gaming facilities, such as casinos, may communicate with customers using direct mail, radio advertising, printed ads, and/or Internet promotions. In response to such communications, people may be enticed to frequent gaming facilities more often.

### SUMMARY

In general, this specification describes systems and methods for messaging gaming patrons. In some implementations, game play for gaming patrons may be monitored and personalized offers based on patrons' game play may be texted to the patrons' cell phones.

In a first general aspect, a computer-implemented method is described. The method includes monitoring game play information transmitted from a gaming device to a server. The monitored information specifies a gaming patron's interactions with the gaming device. The method also includes recording, in a data store of the server, player information comprising the game play information for the gaming patron and a communication device identifier that specifies a communication device associated with the gaming patron.

The method includes generating at the server an electronic message that includes one or more offers personalized for the gaming patron based on the recorded player information and transmitting, using a messaging interface, the electronic message to the communication device specified by the communication device identifier.

In a second general aspect, a system for transmitting electronic messages to a gaming patron based on the gaming patron's interactions with one or more gaming devices is described. The system includes an accounting system installed at a server to monitor game play information transmitted from a gaming device to the server. The monitored information specifies a gaming patron's interactions with the gaming device. The system also includes a player data database to record player information including the game play information for the gaming patron and a communication device identifier that specifies a communication device associated with the gaming patron.

Additionally the system includes a message generator installed at the server to create an electronic message that includes one or more offers personalized for the gaming patron based on the recorded player information and a communication module to transmit the electronic message to the communication device specified by the communication device identifier.

Particular implementations of the subject matter described in this specification can be implemented to realize one or more of the following advantages. First, a gaming facility can more effectively entice previous patrons to play at the facility by personalizing offers. Also, the systems/methods may permit a patron to retain personal privacy while permitting a gaming facility to construct a user profile for a patron without requiring explicit disclosure of personal information. For example, a patron may text a message to a server in response to a prize contest or promotion. The server may response with a transaction identifier that can be used to identify the patron without requiring any additional information. Subsequent game play by the patron can be monitored based on the transaction identifier instead of personal data identifying the patron (e.g., name). The patron can then be sent personalized offers based on game play. Additionally, even more relevant offers may be offered to patrons by combining previously submitted personal information with monitored game play information.

The details of one or more implementations are set forth in the accompanying drawings and the description below. Other features, aspects, and advantages will become apparent from the description, the drawings, and the claims.

### BRIEF DESCRIPTION OF THE DRAWINGS

FIG. 1 is a schematic of an example system for player communication using player performance and demographic information.

FIG. 2 is a schematic showing more detail for the player communication system of FIG. 1.

FIG. 3 is a flow chart of an example process of generating and outputting text blasts based on user-triggered events.

FIG. 4 is a flow chart of an example process of receiving, processing and handling user messages related to text blasts.

FIG. 5 is an example screen shot of an interface for sending on-demand SMS messages.

FIG. 6 is an example screen shot of an interface for opting a player into automated or on-demand text messaging campaigns.

FIG. 7 is a block diagram of computing devices.

Like reference numbers and designations in the various drawings indicate like elements.

### DETAILED DESCRIPTION

This document describes systems and techniques for sending and receiving messages (e.g., phone calls, SMS texts, emails, etc.) as part of a gaming facility's management system. For example, a system integrated with electronic gaming machines can transmit an SMS message to a person who has previously played one of the gaming machines. The SMS message may be sent out on a predetermined basis. For example, the message may be sent after a certain number of days have passed where the system has not recorded that the player has played one of the gaming machines. In another example, SMS text messages may be sent to players associated with ages over a certain threshold on a “senior citizens” night at a casino. In another example, an SMS text message can be sent to players associated with the female gender on a “ladies' night” at the casino.

In this specification, unless otherwise clear from the context, the terms “person,” “patron,” “gambler,” “customer” and the like are synonymous to anyone who frequents a gaming facility, such as a casino, and can send and/or receive gaming related messages.

The messages can be personalized with information associated with the player based on information stored in the player database. For example, the messages can include an enticement for the player to play a certain gaming machine. For example, a player database may contain information that indicates that a first player is especially interested in the electronic gaming machine “Wheel of Fortune” (e.g., based on information about the player's frequency of play, the last gaming machine played, the amount of money won on a certain gaming machine, etc.). The message sent to the player can offer a certain number or amount of free play(s) if the player comes in during a certain time period or on a certain day.

In other implementations, the message can include information challenging the player to beat the player's previous score (or money won) or the score of another player. For example, if a certain player has a favorite game indicated by frequent play, the system can transmit a message indicating that a new high score (e.g., characterized by point totals or money won, etc.) has been achieved by another player for that game. The message can suggest that the player come in to try and beat the new high score. In other implementations, the system can transmit information about a current jackpot for a game. For example, the system can then send an SMS text message with the amount of money in the jackpot for the game “Wheel of Fortune.”

In other implementations, messages can be sent to players on days that are significant to the players, such as birthdays. The messages can include gifts to the player such as free play for one or more games frequently played by the player, coupons for drinks or other casino amenities, etc.

A player may accumulate points based on how often a player plays, how much money the player spends, which games a player plays, and what time of day or which date the player plays, etc. The messages can include information about the current amount of points that a player has accumulated. The messages can further include information about game play or other casino amenities that can be purchased with the points accumulated by the player.

In some implementations, the messages can also include tax information related to the player's winnings or losses at the casino at which the system is installed.

Rules to transmit messages can be generated through rule-related user inputs or selections. The rules can be stored in a rules database and can dictate under what conditions messages are to be transmitted (e.g., phone numbers, email addresses, and permission granted by the player regarding how and when to be contacted).

In some implementations, the system can collect information from players (or potential players) through direct communication with a player's sending device (e.g., cell phone, telephone, computer, blackberry, etc.). For example, a display or kiosk (e.g., located at a gaming facility such as a casino) can present a message saying that the first user to SMS text a given number wins a prize (e.g., free play, free drinks, etc.). The system can collect the address information for the sending device and may use it in subsequent SMS texting to the player. In some implementations, the winning player can be SMS-texted a redemption number or code which can be taken to a cashier to get more information on obtaining a prize or to redeem the prize, for example.

Similarly, these messages to communicate with the system can be displayed to users over speakers at a casino or in a newspaper ad or in other forms of advertisement.

In other implementations, the winning player is SMS-texted a bar code, which subsequently can be scanned in for redemption of a cash or non-monetary prize.

In yet another embodiment, the user can text the system and receive a player ID in return (and/or a transaction number associated with the SMS text session) if for example, the sending device is not already associated with a player ID in a player database. In some implementations, the phone can be Bluetooth enabled, and one or more gaming machines at a gaming facility at which the system is installed can also be Bluetooth enabled (or enabled with another wireless protocol). When the player approaches the gaming machine, the player's cell phone can communicate that the player (e.g., identified by the player ID that was texted to the player) is the current user at the gaming machine. In this way, the system can passively track players without a player inserting a player card in the gaming machine or otherwise actively applying for a player ID.

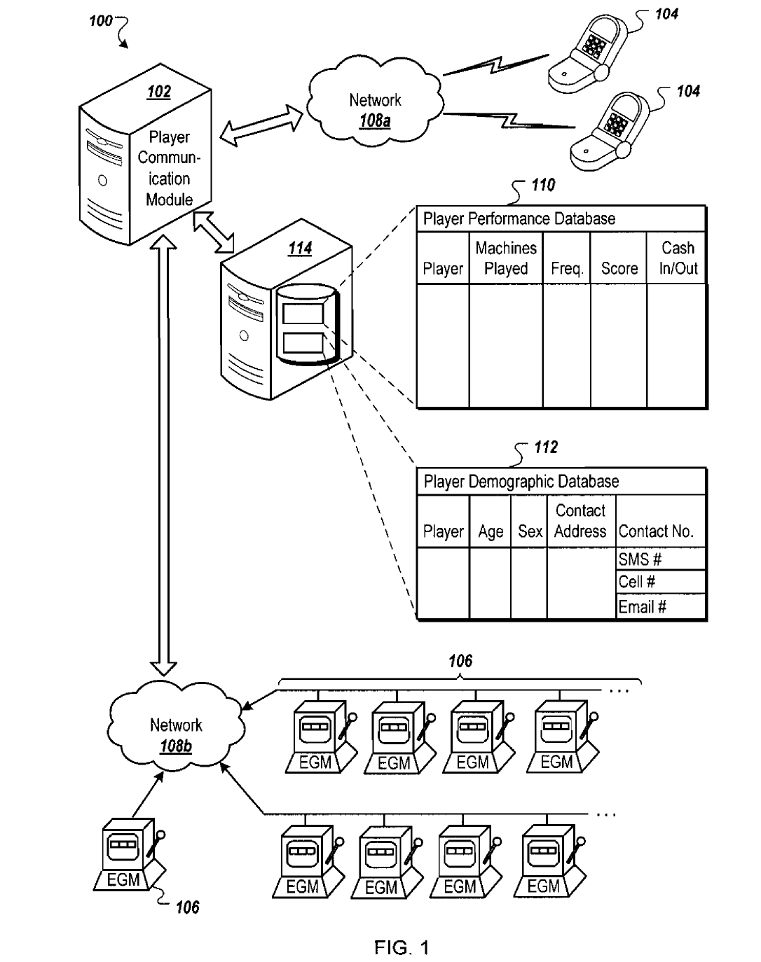

FIG. 1 is a schematic of an example system 100 for player communication using player performance and demographic information. The system includes a player communication module 102 that can provide communication between user devices 104 and electronic gaming machines 106. For example, the user devices 104 can be any of the player's sending devices (e.g., cell phone, telephone, computer, blackberry, etc.) as described above.

Communication can occur using networks 108a and 108b. For example, communication facilitated by the networks 108 can be in the form of a wireless or other network, including the Internet, that can allow a user's portable device to communicate throughout the world. Similarly, the network 108b can be any wired or wireless network, such as a LAN, WAN, the Internet or other network, capable of communicatively coupling multiple electronic gaming machines 106 to the player communication module 102. For example, the network 108b can be a LAN at a gaming facility, such as a casino.

The player communication module 102 can use a player performance database 110 and a player demographic database 112. The player performance database 110 can include information about each player's past performance, such as the player's identification (e.g., name, contact information, etc.), the machines played (e.g., specific machines on the casino floor), the frequency of play, the scores obtained, and the money spent and/or won by the player. The player demographic database 112 can include the player's ID, age, gender, contact address, and contact information (e.g., SMS#, cell phone number #, email address, etc.). The databases 110 and 112 can be stored in a database server 114 or other similar way.

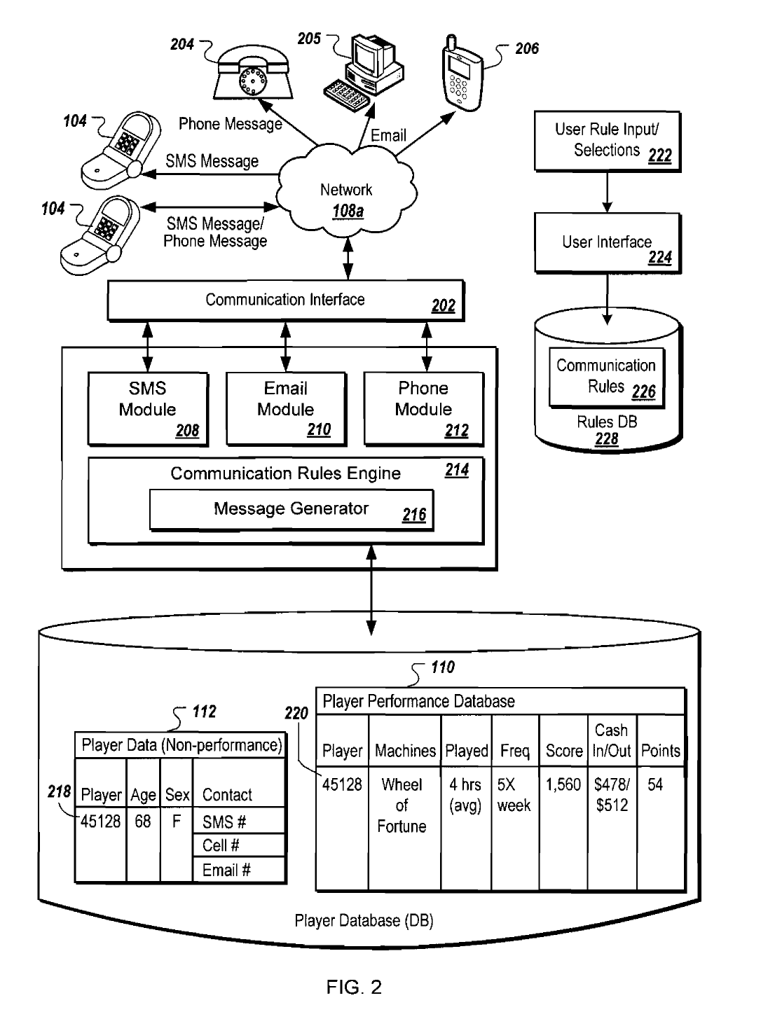

FIG. 2 is a schematic showing more detail for the player communication system 100 of FIG. 1. The system 100 includes the player communication module 102, the player performance database 110 and the player demographic database 112. In this instance, the player demographic database 112 can include any non-performance data, such as demographic information. The system 100 includes a communication interface 202 that facilitates communication between the player communication module 102 and the user's portable devices, such as user devices 104, and electronic gaming machines 106. Other user portable devices can include other phones 204 and any number of smartphones/PDAs 206.

The player communication module 102 can include several modules, such as an SMS module 208, an email module 210, a phone module 212, and a communication rules engine 214. The communication rules engine 214 can further include a message generator 216 capable of formulating messages that the player communication module 102 can send to various user devices 104 and the like.

As depicted, the player demographic database 112 includes an entry 218 in which the associated player, a 68-year-old female, is further identified by a player ID of 45128. The player's entry in the player demographic database 112 can be the result of, for example, the user's past play on one or more games at the casino. Similarly, the woman's past performance data can be stored in the player performance database 110. For example, as depicted in an entry 220, the woman (whose player ID is 45128) has in the past played the “Wheel of Fortune” machine or game, for an average of four hours, five times a week. Her last recorded score (which may be her record score) is 1,560. As indicated by cash in/out fields, the woman has spent $478 and won $518. The player performance database 110 can also track the woman's “points” (e.g., 54, as depicted) which can represent points accumulated toward one or more promotion (e.g., free play, free drinks, other special promotions, etc.).

The system 100 also includes modules and databases used for defining communication rules. For example, a user rule input/selection module 222 can allow gaming operators to identify the conditions under which users (e.g., casino customers) are contacted via messages. The definition of the rules can be facilitated using a user interface 224. As a result, communication rules 226 can be stored in a rules database 228.

The rules database 228 can be stored locally at the gaming facility, or it can be part of a combined and/or distributed database stored remotely that serves several gaming facilities, such as a chain of casinos owned by the same entity. In this way, a player's performance-related and non-performance-related data can be shared among all of the gaming facilities that the player may frequent.

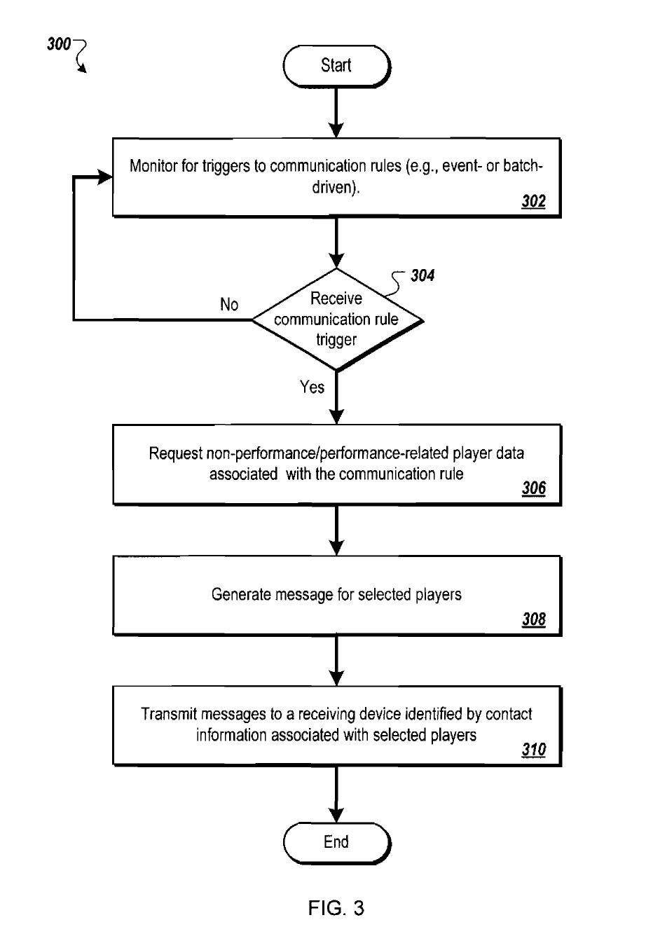

FIG. 3 is a flow chart of an example process 300 of generating and outputting text blasts based on user-triggered events. The process 300 can be used, for example, in generating text messages associated with the system 100 described with reference to FIGS. 1 and 2. For example, casinos or other gaming facilities can use the process 300 to generate electronic messages, including offers that are personalized for gaming patrons (e.g., based on the gaming-related data and the gaming patron) and transmitting the messages (e.g., using a messaging system) to the patrons' communication devices. The messages transmitted can use player information that has been recorded over time. The player information can include gaming-related data for a gaming patron that specifies the gaming patron's interactions with a gaming device at a gaming facility, and a communication device identifier that specifies a communication device associated with the patron.

Triggers to communication rules (e.g., event- or batch-driven) are monitored in step 302. The triggers can include, for example, the patron's entrance to or exit from a gaming facility, or the passage of time since the last visit by the patron to the gaming facility. Other events that can serve as triggers can be events related to a patron's favorite gaming device (e.g., a new higher score has been recorded by another patron) or the installation of a gaming device believed to be of interest to the patron (e.g., based on demographic information stored for the patron).

The communication rule trigger is received in step 304. The receipt can include, for example, the recording of the event by the system 100.

Non-performance/performance-related player data associated with the communication rule is requested in step 306. For example, depending on the event related to one or more patrons, the non-performance-related (e.g., demographic) data and performance-related (e.g., based on one or more gaming devices and the interaction by the patron thereon) are retrieved.

One or more messages for selected players are generated in step 308. For example, the messages can include patron-specific messages that identify information about specific gaming devices or general promotions associated with the gaming facility.

Messages are transmitted to a receiving device identified by contact information associated with selected players in step 310. For example, based on the contact information associated with a patron, the messages for that patron can be sent to the patron's receiving device, such as a cell phone or other portable (or non-portable) device capable of receiving email or an electronic page. In some situations, advantages can be achieved by sending messages to non-portable devices, such as a patron's home PC or work computer, such as to entice the patron to play after work or on the weekend.

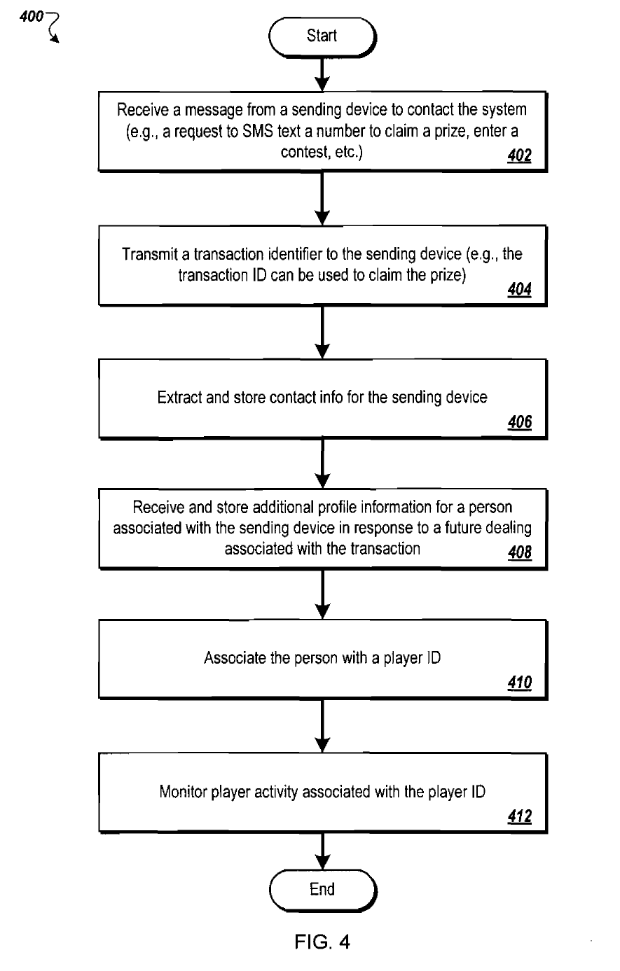

FIG. 4 is a flow chart of an example process 400 of receiving, processing and handling user messages related to text blasts. The process 400 can be used, for example, in the messaging scenarios described above and with regards to the system 100.

A message is received from a sending device to contact the system (e.g., a request to SMS text a number to claim a prize, enter a contest, etc.) in step 402. For example, a patron can send a text message of this kind in response to a message received.

A transaction identifier is transmitted to the sending device (e.g., the transaction ID can be used to claim the prize) in step 404. For example, a message displayed on the patron's cell phone can describe how to claim a prize by reciting the prize ID (e.g., “Use secret code NBF0929 to claim your prize!”).

Contact info for the sending device is extracted and stored in step 406. As will be described in more detail below, the contact information can include the patron's cell phone number and other information which can describe how the patron is to be contacted with gaming-related messages.

Additional profile information for a person associated with the sending device is received and stored in response to a future dealing associated with the transaction in step 408.

The person is associated with a player ID in step 410. For example, the player ID and other information associated with the player can be recorded in the player demographic database 112.

Player activity associated with the player ID is monitored in step 412. For example, the gaming devices played by the patron can be tracked, and the patron's scores, dollars spent and associated winnings on those games can be recorded. The information can be stored, for example, in the player performance database 110.

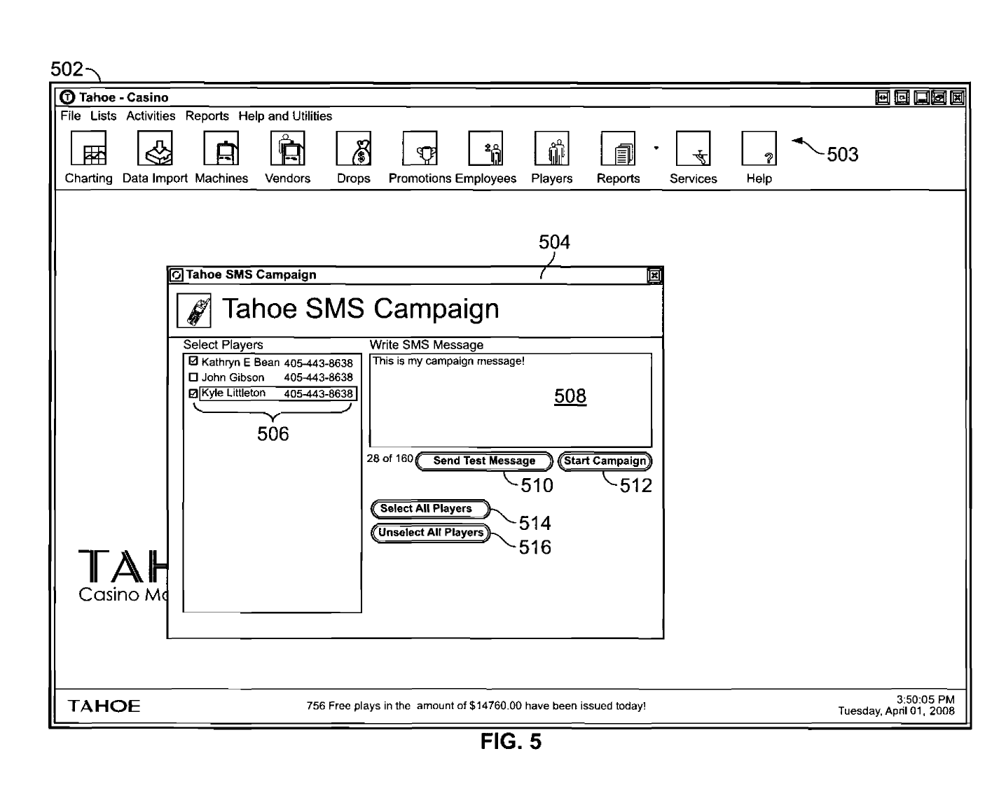

FIG. 5 is an example screen shot of an interface for sending on-demand SMS messages. The screen shot includes a main screen 502 which can, for example, be an application run by a gaming facility (such as the TAHOE Casino Management application developed by EC Development of Shawnee, Okla.). The screen 502 can include several controls 503 that can be individually selectable by a user employing the application, such as casino staff who manage campaigns. For example, upon selecting one of the controls 503 (e.g., any of the icons representative of the corresponding function), a campaign window 504 can appear (e.g., entitled “Tahoe SMS Campaign”).

The campaign window 504 can include several data areas, such as a player selection area 506 that lists, for example, player names and their corresponding phone numbers. For instance, the player selection area 506 can define the players associated with the gaming facility and their cell phones that are currently defined or configured for communicating SMS messages related to gaming communications. The campaign window 504 can also include an SMS message window 508, identifying the SMS message that can be sent to defined recipients.

Multiple controls 510-516 can allow the user of the screen 502 to control how messages are sent to selected players. For example, the send test message control 510 can format and transmit a sample campaign message to a pre-determined device, the message being the one that is currently defined or displayed in the SMS message window 508. The start campaign control 512 can allow the user to initiate an SMS campaign, such as the one represented by the current message in the SMS message window 508. Initiating the campaign can, for example, send a message to each of the selected players (e.g., based on checkbox selections in the player selection area 506) in order to display on their portable devices an initial message regarding the campaign.

Controls such as the select all players button 514 and the unselect all players button 516 can make it easier for the user of the screen 502 to select (or deselect) all players' names without having to check (or uncheck) all of the individual checkboxes. Other controls not shown can allow the easy identification of groups of players, such as all female players over a certain age who spend a lot of time (and money) playing Wheel of Fortune.

Other controls not depicted in FIG. 5 can be used, for example, to step through or navigate among the various campaigns defined for a given gambling facility, such as a campaign for reduced or free play on amusement machines, free prizes, or other campaigns.

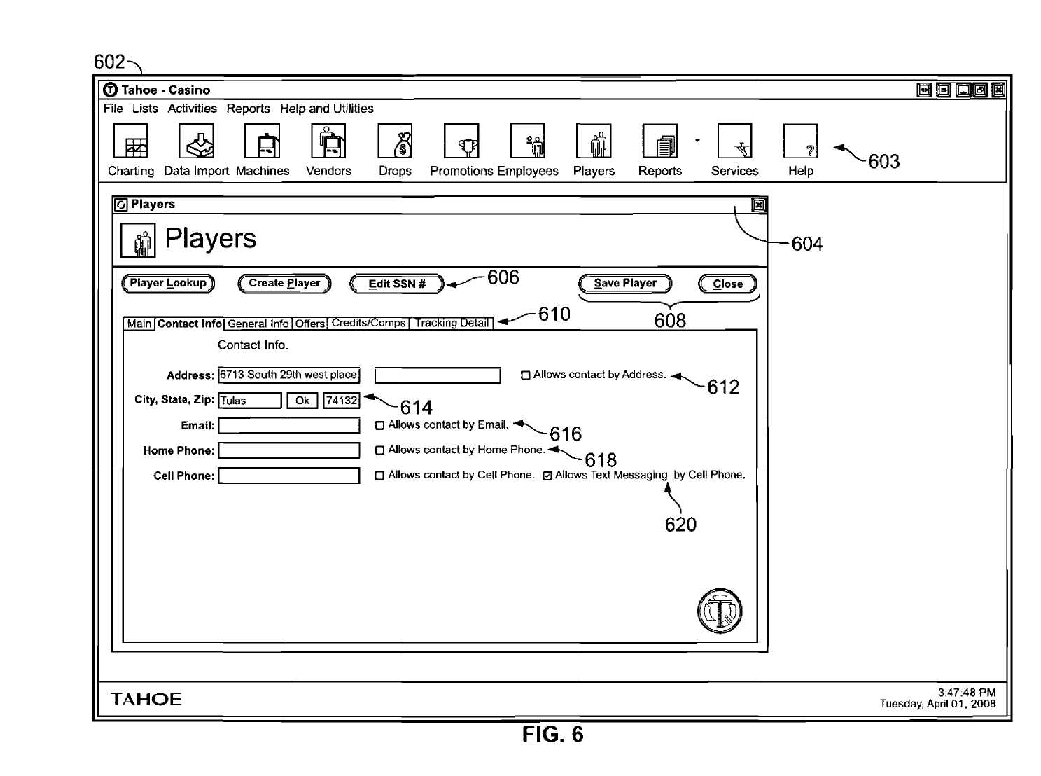

FIG. 6 is an example screen shot of an interface for opting a player into the automated or on-demand text messaging campaigns. For example, a screen 602 can provide numerous controls 603, which may or may not be similar to the controls 503 described in reference to FIG. 5. For example, upon selecting one of the controls 603, a window such as a players window 604 can be displayed.

The players window 604 can include several controls 606, such as button to look up a player, create a player, edit a player's social security number (SSN), etc. For example, players' SSNs can be on file at a casino as needed to report significant player winnings (or losses) to the Internal Revenue Service (IRS) or other taxing authorities. The players window 604 can also include controls 608 which can allow the currently displayed (e.g., looked up and edited) player information to be saved, or allow the window to be closed, to name a few examples.

In some implementations, if a patron wins a very large sum of money and cashes out, the system can send a message to the patron's mobile device indicating security, bank, cash deposit, or other services available at the casino. Some of the services can be offered as a way to use up points accumulated by the patron.

If information for a player is currently looked up and on display within the players window 604, the user (e.g., casino management staff) of the screen 602 can select from various controls 610 to perform specific operations using players data. For example, the controls 610 can include tabs for editing player contact information, general information for a player, offers associated with a player, accounting information (e.g., credits, charges, etc.), and tracking information.

In one example, if a player's contact information is being edited, various lines 612-620 can be displayed. The address line 612 can include two or more address fields and checkboxes, such as whether the player has authorized contact by U.S. Postal mail at the specified address. The city/state/ZIP line 614 can include separate fields for each of the player's city, state and ZIP Code values. The email line 616 can include one or more email address fields and checkboxes, such as whether the player has authorized contact by email at the specified email address. The home phone line 618 can include, for example, a phone number field for specifying the player's home phone number and a checkbox for specifying whether the player has authorized contact by phone. The cell phone line 620 can include, for example, a cell phone number field for specifying the player's cell phone number (or numbers for smartphones or other portable devices) and a checkbox for specifying whether the player has authorized voice contact by cell phone. An additional checkbox can show whether the player has authorized the receipt of text messages on his cell phone or other such device.

Other patron-related data that can be entered using screens such as the screen 602 can include, for example, the monetary units to which the patron is accustomed. For example, patrons can pre-specify that they want the amounts displayed in messages to be represented in US dollars, Euros, yen, or any other form of multi-currency. In another example, the patron may have pre-specified that messages received be written in English, Spanish, Japanese, etc.

The systems described may enable gaming facilities to communicate directly with patrons and the general public via the widely available SMS messaging capabilities of modern cell phones. For example, the system 100 can include software and hardware necessary for implementing this service at a given casino.

In some implementations, text or multi-media messages can be sent to casino or other gaming facility patrons who already exist or sign up for the player tracking system present at a given casino. The messages may be targeted, for example, based on casino customizable reports which can narrow down results to specific demographics of players. Such targeted messages can be performed on a schedule or launched on-demand.

In some implementations, text or multi-media messages can be sent to anyone who, for example, opts in via “Text-in” or other such offers. The offers can be displayed or sent via mass advertising campaigns, such as billboards, newspaper ads, magazine ads, web ads, television commercials, or radio advertising.

Some implementations can include an automated sign-up system whereby anyone (e.g., non-patrons or new patrons) may enroll themselves in a limited fashion into the player tracking database by simply opting in to one of the “Text-in” offers.

Some implementations can allow existing patrons to sign up for “players only” promotions through a similar system by “Texting-in” using a specific code presented in one or more advertising mediums.

Some implementations can allow selection of a “winner” to casino-initiated events whereby the winner is sent a customizable offer to their cell phone or other portable email device.

Some implementations can allow players to “Text-in” for a “Chance to WIN!” promotion. For example, using data aggregation systems (e.g., demographic data), this event may be casino-initiated or may be automatically initiated based on rules or analyzed player tracking data.

Some implementations can allow host casinos to send out surveys coupled to promotional offers, whereby the patron or non-patron is asked a survey question for a “chance to win” or a “guaranteed offer” in return for their survey time.

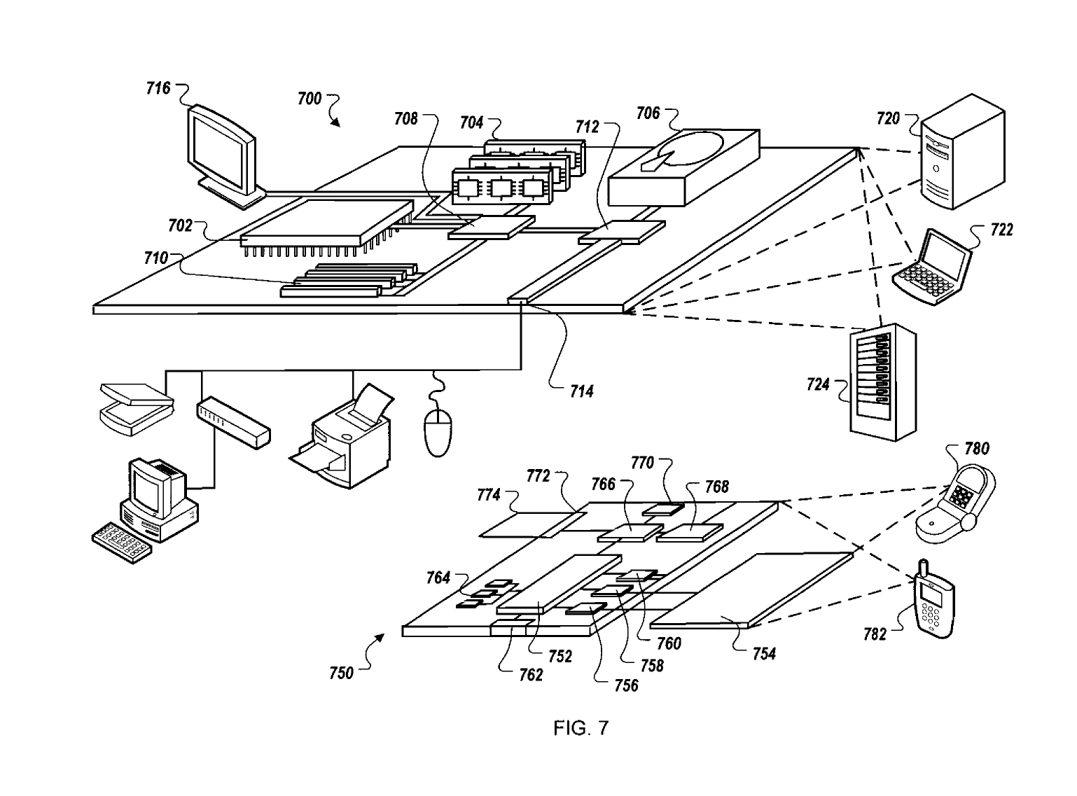

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communication audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method comprising:
monitoring game play information transmitted from a gaming device to a server, the monitored information specifying a gaming patron's interactions with the gaming device;
recording, in a data store of the server, player information comprising the game play information for the gaming patron and a communication device identifier that specifies a communication device associated with the gaming patron;
generating at the server an electronic message that includes one or more offers personalized for the gaming patron based on the recorded player information; and
transmitting, using a messaging interface, the electronic message to the communication device specified by the communication device identifier.

2. The method of claim 1, wherein the player information further comprises demographic information for the gaming patron.

3. The method of claim 2, further comprising receiving the demographic information from the gaming patron for subsequent recording in the data store.

4. The method of claim 2, further comprising generating and transmitting a second electronic message based on the demographic information for the gaming patron.

5. The method of claim 2, wherein the one or more offers personalized for the gaming patron is also based on the demographic information for the gaming patron.

6. The method of claim 1, wherein the game play information comprises identification of the gaming device played, frequency of play, duration of play, high scores, money spent or money won.

7. The method of claim 1, wherein the one or more offers comprise offers for free play on the gaming device, offers for free play on gaming devices that are similar to the gaming device, complementary products or services for engaging in gaming at a gaming facility having the gaming device, invitations to better a score achieved on the gaming device, or notification of a prize associated with the gaming device.

8. The method of claim 1, wherein the gaming device comprises an electronic device for use in gambling.

9. The method of claim 1, wherein the monitoring of the game play information is performed by an accounting system installed at the server.

10. The method of claim 1, wherein the server is hosted by more than one computer.

11. The method of claim 1, wherein the communication device comprises a portable email device, a cell phone, an electronic portable data assistant, or a personal computer.

12. The method of claim 1, wherein the messaging interface comprises an email server, a short message service (SMS) server, or a voice over internet protocol (VOIP) server.

13. The method of claim 1, further comprising generating synthesizing speech based on text included in the one or more offers.

14. The method of claim 13, wherein the electronic message is transmitted as synthesized speech to the communication device specified by the communication device identifier.

15. The method of claim 1, further comprising receiving an initial electronic message from the communication device having the communication device identifier.

16. The method of claim 15, further comprising transmitted a transaction identifier to the communication device in response to the received initial electronic message.

17. The method of claim 16, wherein the transaction identifier is proof of entry in a contest.

18. The method of claim 17, further wherein the transaction identifier is configured to be transmitted to another electronic device for redemption of a prize.

19. The method of claim 16, wherein the communication device identifier is used as a proxy for an identifier specifying a particular gaming patron.

20. The method of claim 1, wherein the one or more offers comprise tax-related information associated with the gaming patron's winnings or losses at a gaming facility having the gaming device.

21. A system for transmitting electronic messages to a gaming patron based on the gaming patron's interactions with one or more gaming devices, the system comprising:
an accounting system installed at a server to monitor game play information transmitted from a gaming device to the server, the monitored information specifying a gaming patron's interactions with the gaming device;
a player data database to record player information comprising the game play information for the gaming patron and a communication device identifier that specifies a communication device associated with the gaming patron;
a message generator installed at the server to create an electronic message that includes one or more offers personalized for the gaming patron based on the recorded player information; and
a communication module to transmit the electronic message to the communication device specified by the communication device identifier.

22. A computer program product tangibly embodied in a computer readable storage device, the computer program product including instructions that, when executed, perform operations for transmitting electronic messages to a gaming patron based on the gaming patron's interactions with one or more gaming devices, the operations comprising:
monitoring game play information transmitted from a gaming device to a server, the monitored information specifying a gaming patron's interactions with the gaming device;
recording, in a data store of the server, player information comprising the game play information for the gaming patron and a communication device identifier that specifies a communication device associated with the gaming patron;
generating at the server an electronic message that includes one or more offers personalized for the gaming patron based on the recorded player information; and
transmitting, using a messaging interface, the electronic message to the communication device specified by the communication device identifier.
